(19) United States
(12) Patent Application Publication
(10) Pub. No.: US 2026/0231849 A1
(43) Pub. Date: Aug. 13, 2026

(54) ARTICLES AND METHODS FOR DEPOSITING SEEDS

(71) Applicant: THE CARLSTAR GROUP LLC, Franklin, TN (US)

(72) Inventors: Kevin McMichen, Medina, TN (US); Mitesh Chahar, Jackson, TN (US); David Dahl, Jackson, TN (US)

(73) Assignee: The Carlstar Group LLC, Franklin, TN (US)

(21) Appl. No.: 19/156,616

(22) PCT Filed: Feb. 15, 2024
(86) PCT No.: PCT/US2024/015929

§ 371 Date: Aug. 14, 2025

Related U.S. Application Data
(60) Provisional application No. 63/445,860, filed on Feb. 15, 2023.

(51) Int. Cl. A01C 5/06

(52) U.S. Cl. CPC A01C 5/066

(57) ABSTRACT

Provided herein are spiked closing wheels. The spiked closing wheel includes a body portion having a first side, a second side, and an outer surface extending between the first side and the second side; and a plurality of teeth extending outwardly from the outer surface. At least one of the teeth extends from the outer surface at an angle with respect to a plane perpendicular to an axis of rotation of the wheel.

### CROSS-REFERENCE TO RELATED APPLICATIONS

The present application claims priority under 35 U.S.C. § 119(e) to U.S. Provisional Patent Application No. 63/445,860, filed Feb. 15, 2023, which is hereby incorporated herein by reference in its entirety.

### BACKGROUND OF THE INVENTION

During a planting operation, a tractor driven planter creates a furrow in the soil to deposit seed. Once the seed has been deposited, the furrow has to be closed to pack soil around the seed. This is typically done by a pair of closing wheels. As illustrated in FIG. 1, existing closing wheels usually consist of rubber tires clinched between two plastic wheel halves, rotating about a bearing. Despite their longstanding use, these rubber closing wheels are generally not able to satisfactorily close the furrow, thus leaving seeds exposed in many scenarios.

Accordingly, there is a need in the art for articles and methods that improve on existing articles and methods for sowing seeds. The present invention addresses this need.

### BRIEF DESCRIPTION OF THE DRAWINGS

For a fuller understanding of the nature and desired objects of the present invention, reference is made to the following detailed description taken in conjunction with the accompanying figures wherein like reference characters denote corresponding parts throughout the several views.

FIG. 1 shows an example of existing closing wheels.

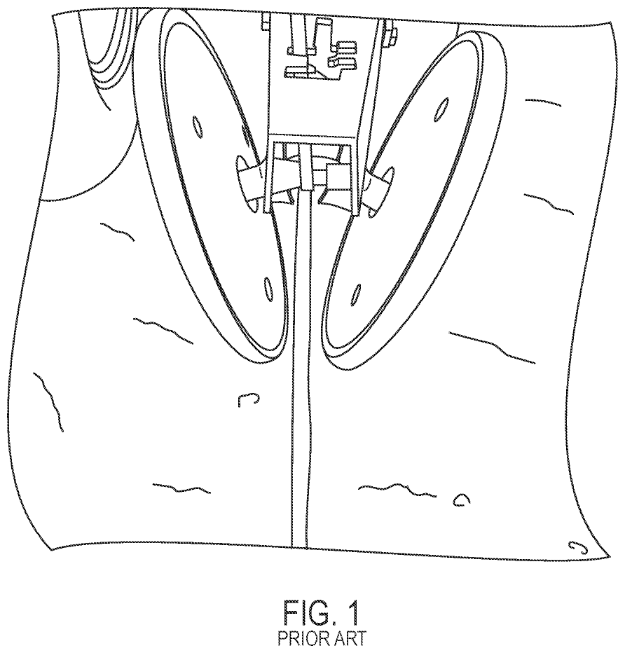

FIG. 2 shows a perspective view of a spiked closing wheel, according to an embodiment of the disclosure.

FIG. 3 shows a front view of the spiked closing wheel of FIG. 2.

FIG. 4 shows a section view of the spiked closing wheel of FIG. 2.

FIG. 5 shows a section view of a tooth in the spiked closing of FIG. 2.

FIG. 6 shows a section view of a tooth in the spiked closing of FIG. 2.

FIG. 7 shows a schematic illustrating a method of closing a furrow using the spiked closing wheels disclosed herein.

FIG. 8 shows a front view of a spiked closing wheel, according to an embodiment of the disclosure.

FIG. 9 shows a perspective view of the spiked closing wheel of FIG. 8.

FIG. 10 shows a section view of the spiked closing wheel of FIG. 8.

FIG. 11 shows a section view of a tooth in the spiked closing of FIG. 8.

FIG. 12 shows a front view of a spiked closing wheel, according to an embodiment of the disclosure.

FIG. 13 shows a perspective view of the spiked closing wheel of FIG. 12.

FIG. 14 shows a section view of the spiked closing wheel of FIG. 12.

FIG. 15 shows a section view of a tooth in the spiked closing of FIG. 12.

FIG. 16 shows a front view of a spiked closing wheel, according to an embodiment of the disclosure.

FIG. 17 shows a perspective view of the spiked closing wheel of FIG. 16.

FIG. 18 shows a section view of the spiked closing wheel of FIG. 16.

FIG. 19 shows a section view of a tooth in the spiked closing of FIG. 16.

FIG. 20 shows a front view of a spiked closing wheel, according to an embodiment of the disclosure.

FIG. 21 shows a perspective view of the spiked closing wheel of FIG. 20.

FIG. 22 shows a section view of the spiked closing wheel of FIG. 20.

### DETAILED DESCRIPTION OF THE INVENTION

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

The articles “a” and “an” are used herein to refer to one or to more than one (i.e., to at least one) of the grammatical object of the article. By way of example, “an element” means one element or more than one element.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION

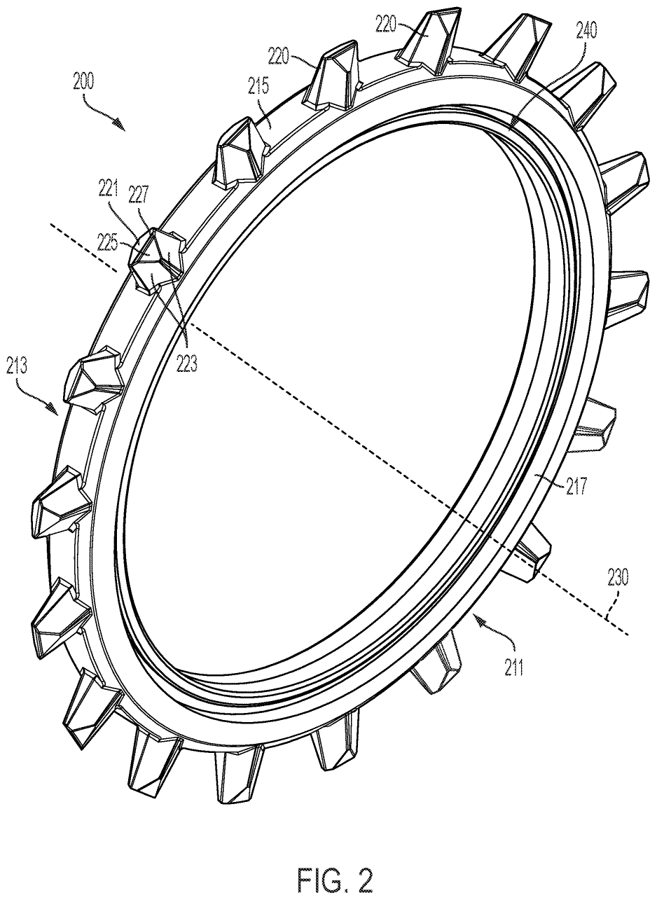

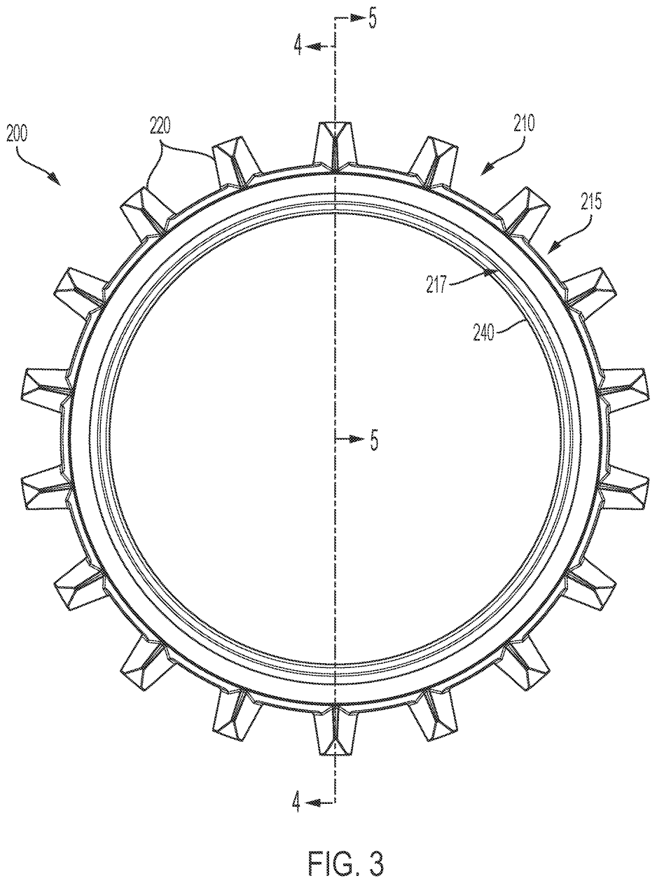

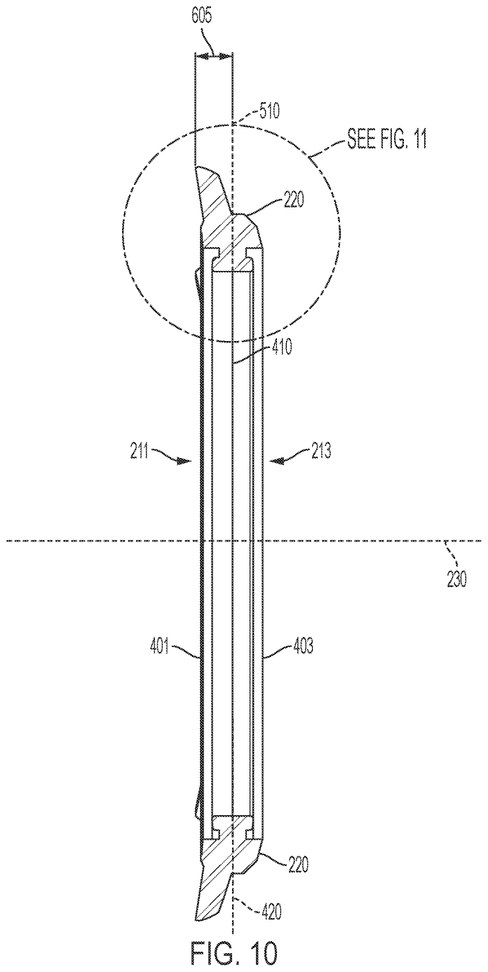

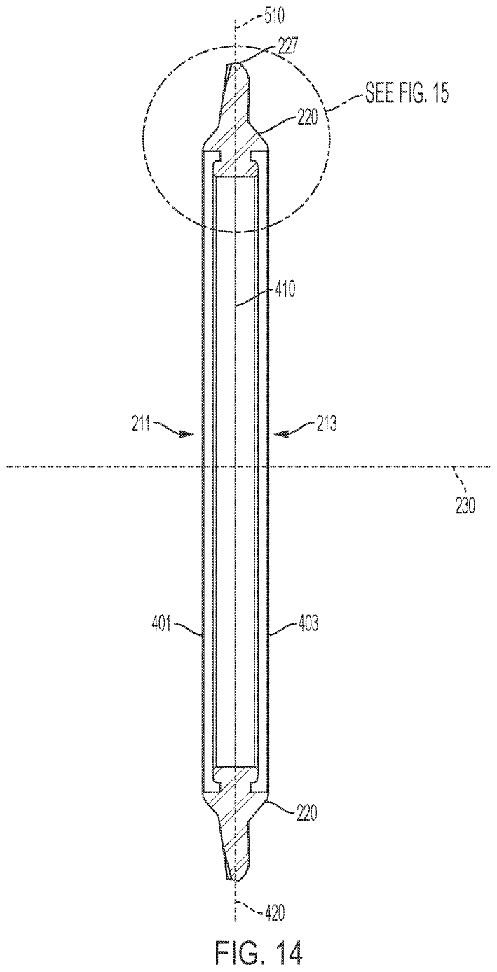

Provided herein are articles and methods for depositing seeds. In some embodiments, as illustrated in FIGS. 2-4, 8-10, and 12-14, the article includes a spiked closing wheel 200 having a body portion 210 and one or more teeth 220. The one or more teeth 220 extend outwardly from the body portion 210 such that when the wheel 200 is rotated about an axis of rotation 230, the teeth 220 are sequentially rotated in the same direction. For example, when the wheel 200 is mounted to a support, such as a frame, the teeth 220 sequentially engage with the soil as the body portion 210 is rotated along the ground.

The body portion 210 includes a toroidal shape defined by a first side 211, a second side 213 opposite the first side 211, an outer surface 215, and an inner surface 217 opposite the outer surface 215. The first side 211 and the second side 213 independently include any suitable shape extending between the outer surface 215 and the inner surface 217, and define a radial height of the body portion 210. In some embodiments, the first side 211 and the second side 213 mirror each other. For example, in one embodiment, the first side 211 and the second side 213 are flat and parallel. In such embodiments, the outer surface 215 and the inner surface 217 have the same width extending in the axial direction. In another embodiment, the first side 211 and the second side 213 are curved or arched in mirroring fashion. In still another embodiment, the first side 211 and the second side 213 are inwardly or outwardly angled, in mirroring fashion, such that either the inner surface 217 or the outer surface 215 is wider than the other (e.g., the body portion has a trapezoidal toroidal shape).

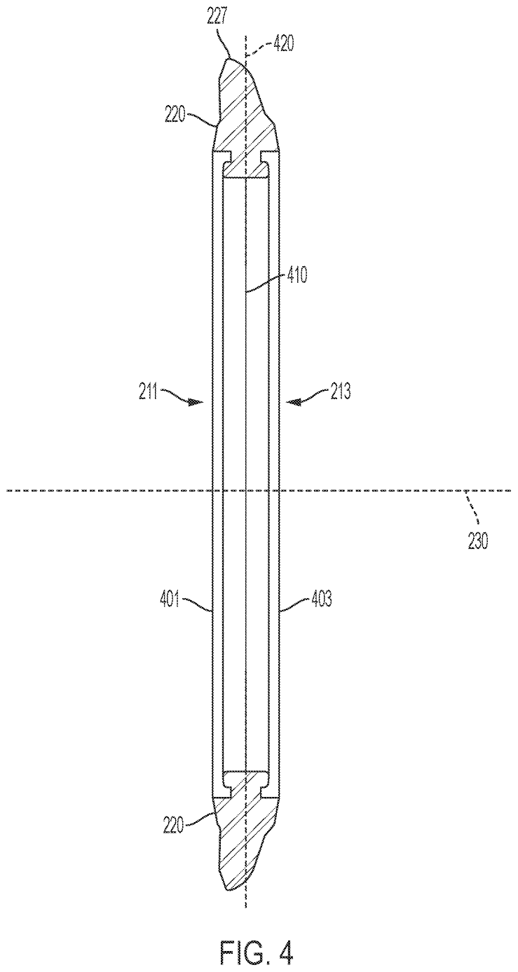

Additionally or alternatively, in some embodiments, as best illustrated in FIGS. 4, 10, and 14, the body portion 210 includes a first body section 401 and a second body section 403. The first body section 401 and the second body section 403 are reversibly secured to each other to form the body portion 210. As will be appreciated by those skilled in the art, the body portion 210 may be split between the first body section 401 and the second body section 403 in any suitable proportion. For example, as illustrated in FIGS. 4, 10, and 14, the body portion 210 may be split down a centerline 410 thereof such that the first body section 401 and the second body section 403 are equally sized. In such embodiments, the first body section 401 includes the first side 211 and the second body section 403 includes the second side 213.

As best illustrated in FIGS. 2-3, 8-9, and 12-13, the outer surface 215 defines a perimetral shape of the body portion 210, and has a width extending between the first side 211 and the second side 213. The perimetral shape includes any suitable shape for rotating the teeth 220 about an axis of rotation 230, such as, but not limited to, circular, substantially circular, toroidal, or any other shape for sequentially rotating the teeth 220 into and out of contact with a surface. Similarly, the width of the outer surface 215 includes any suitable shape in the axial direction. In some embodiments, for example, the outer surface 215 defines a circular perimetral shape while being flat between the first side 211 and the second side 213 in the axial direction. Alternatively, in some embodiments, the outer surface 215 is rounded, angled, stepped, includes any other suitable non-flat shape in the axial direction (i.e., between the first side 211 and the second side 213), or a combination thereof. For example, in one embodiment, the outer surface 215 is substantially flat in the axial direction across a middle section and includes beveled edges leading from the flat axial middle section to each of the first side 211 and the second side 213.

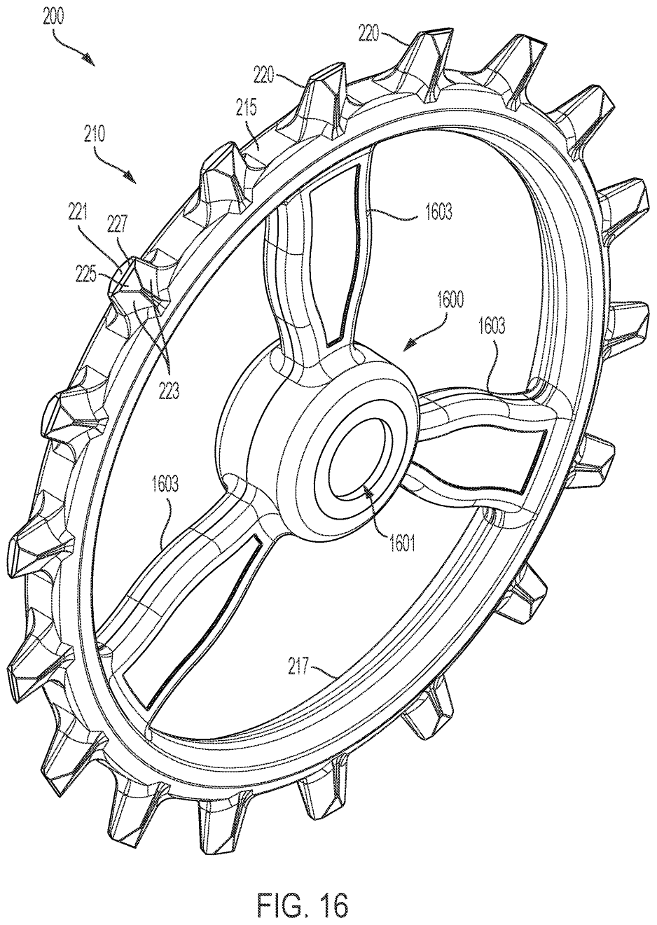

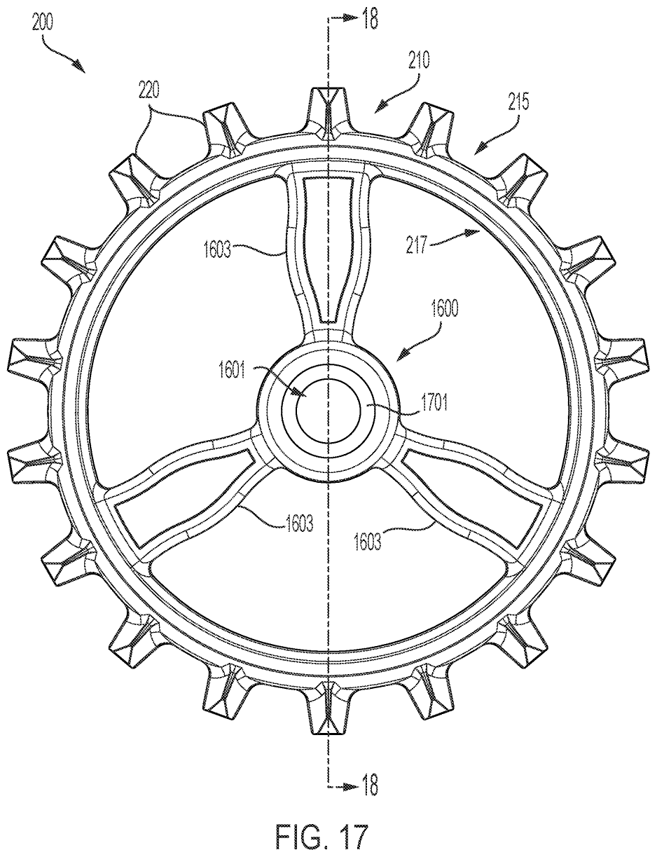

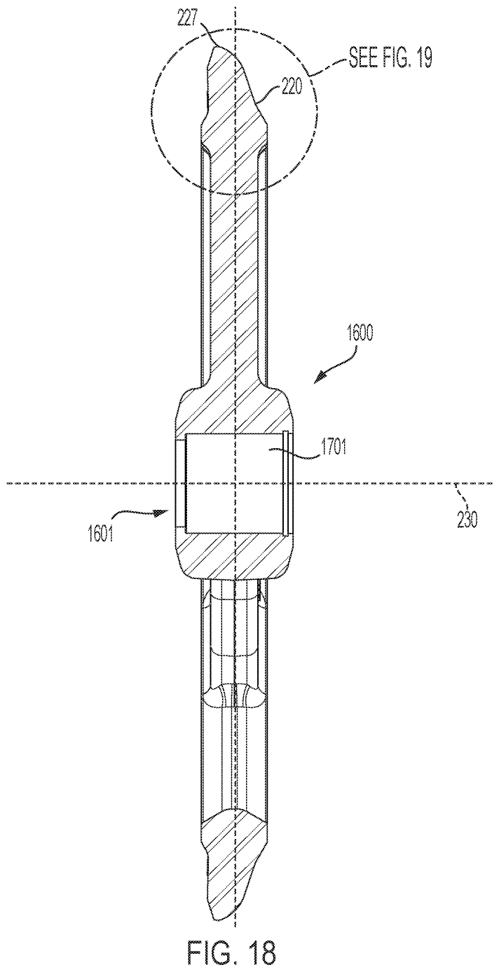

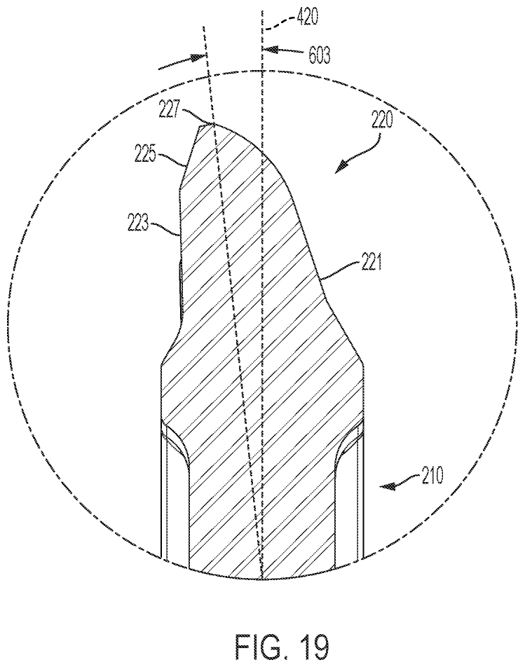

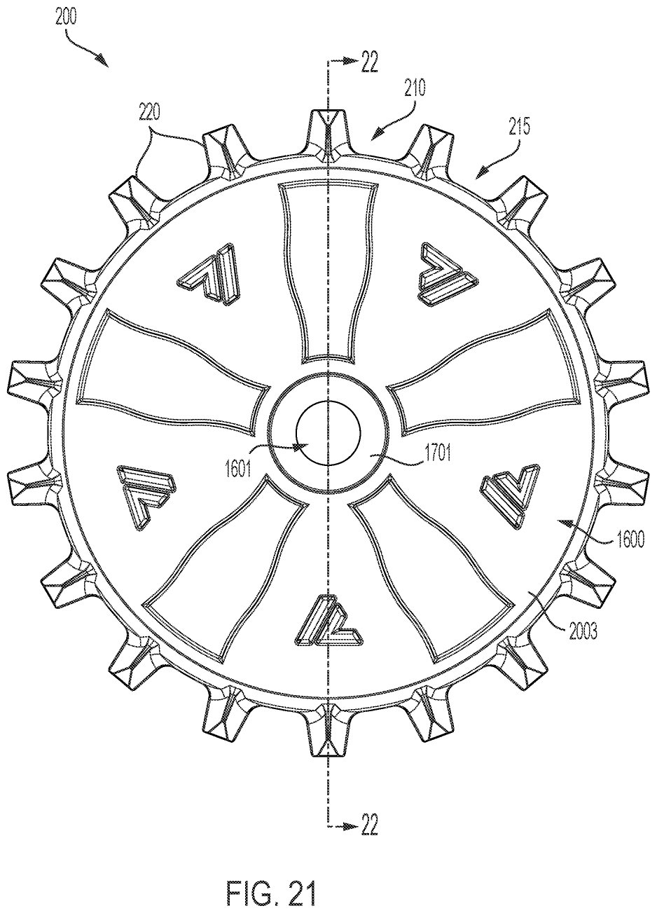

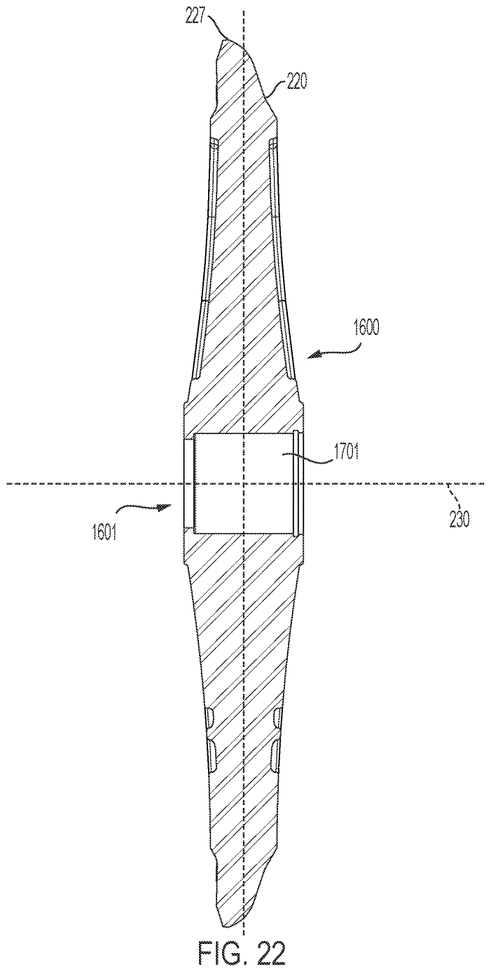

The inner surface 217 is concentric with the outer surface 215, and includes any suitable shape arranged and disposed for mounting the wheel 200 to a frame or other suitable support. In some embodiments, as illustrated in FIGS. 2-3, 8-9, and 12-13, the inner surface 217 includes a hub mounting feature 240. The hub mounting feature 240 includes any suitable shape for securing a hub 1600 (FIGS. 16-22) to the body portion 210. For example, in one embodiment, as illustrated in FIGS. 2-3, 8-9, and 12-13, the hub mounting feature 240 includes a continuous “T” shape extending from the inner surface 217 towards the axis of rotation 230. Other shapes for the hub mounting feature 240 include, but are not limited to, continuous features of any suitable shape (e.g., triangular, circular, etc.) and/or spaced features of any shape (e.g., nail heads, pin heads, pegs, etc.). In such embodiments, the hub 1600 includes any suitable configuration for being reversibly secured to the hub mounting feature 240, such as, but not limited to, detachable first and second hub sections. Alternatively, in some embodiments, the hub 1600 is integrally formed with the wheel 200. In some embodiments, the inner surface 217 is arranged and disposed for direct mounting of the body portion 210 to the frame (i.e., without a hub). In such embodiments, the inner surface 217 of the body portion may include a bearing secured directly thereto.

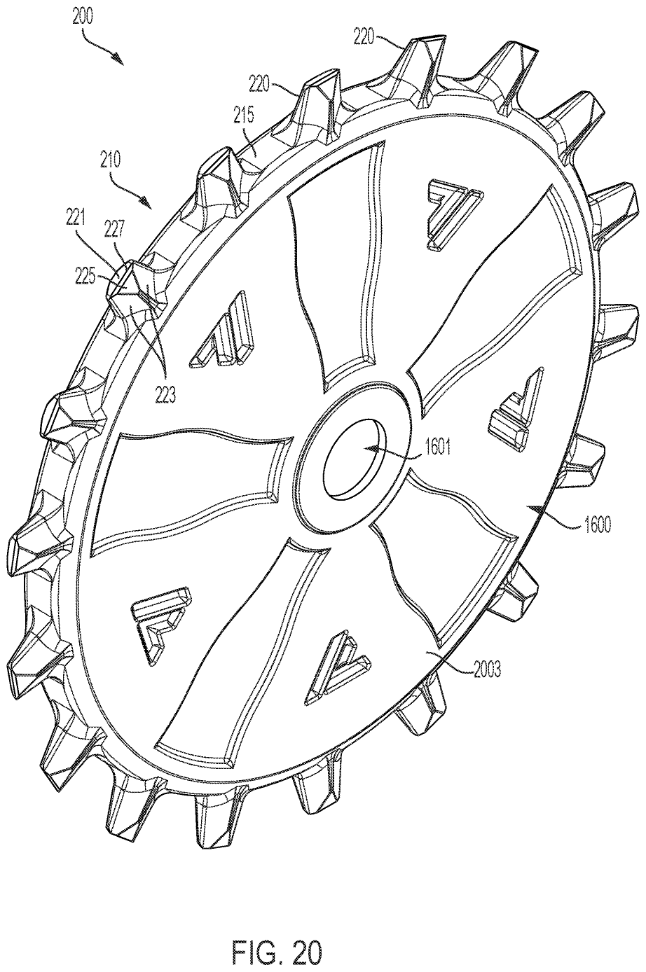

As illustrated in FIGS. 16-22, the hub 1600, when present, includes a central opening 1601 configured to receive a projection from the frame or other suitable support in order to mount the wheel 200 thereto. For example, in some embodiments, the central opening 1601 of the hub 1600 includes a bearing 1701 for rotatably mounting the wheel 200 to a frame. The hub 1600 may include any suitable shape for supporting the wheel 200 when mounted to a frame or other suitable support. Referring to FIGS. 16-18, in some embodiments, the hub 1600 includes any suitable number of spokes 1603, or other supports, extending from the inner surface 217 to the central opening 1601. Turning to FIGS. 20-22, in some embodiments, the hub 1600 includes a continuous material 2003 extending from the inner surface 217 of the wheel 200 to the central opening 1601.

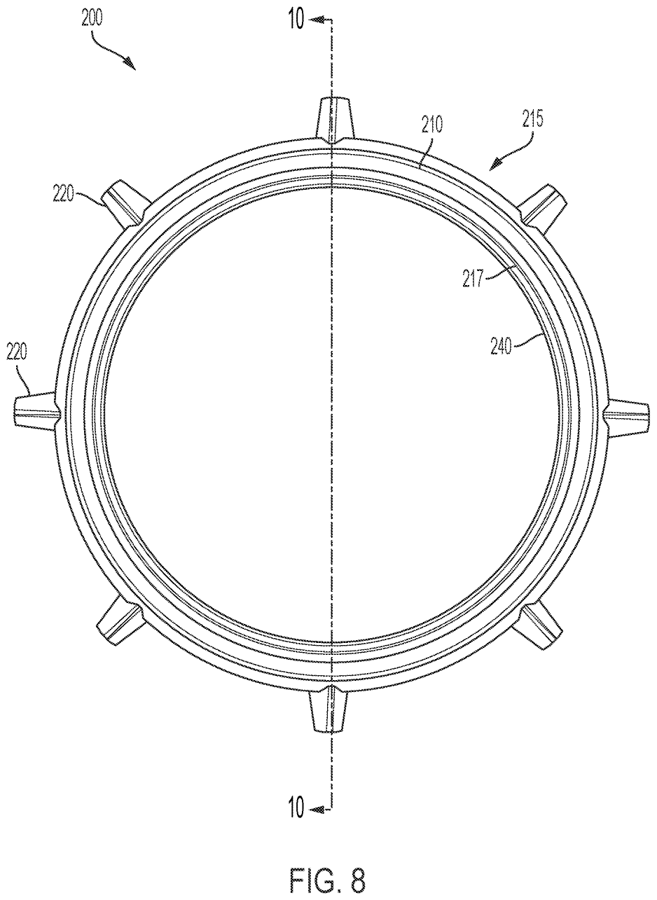

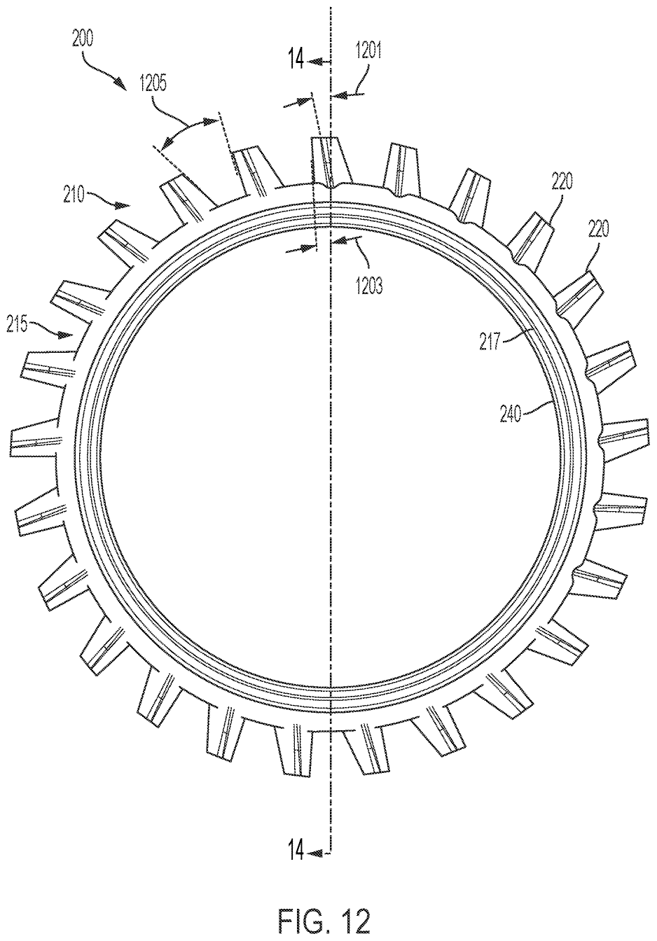

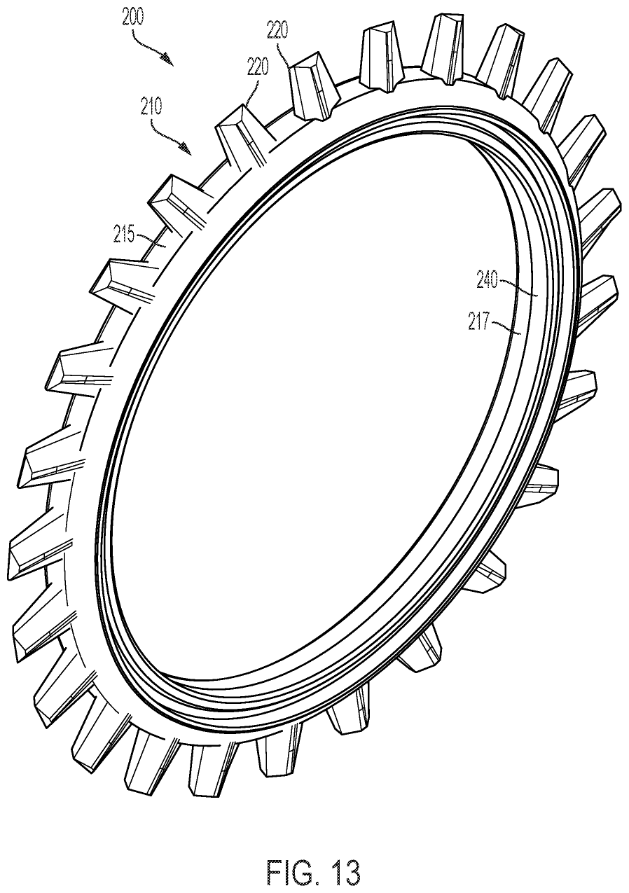

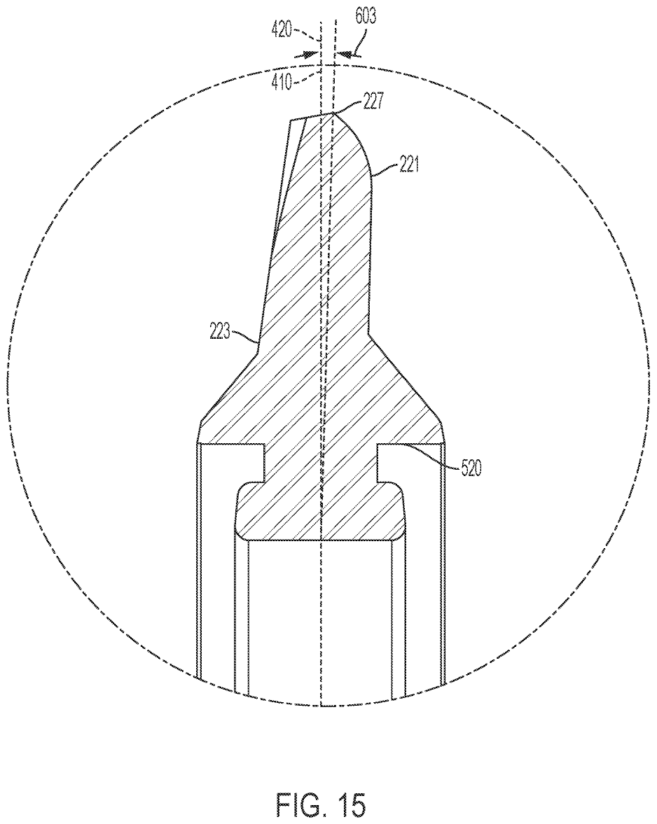

As illustrated in FIGS. 2-4 and 8-15, the teeth 220 extend from and/or through the outer section 215, and are spaced around the perimeter of the body portion 210. Each tooth 220 may be evenly spaced around the perimeter of the body portion 210, or the teeth 220 may include varied spacing. Although various embodiments are illustrated herein with a certain number of teeth (i.e., 18 in FIGS. 2-3, 8 in FIGS. 8-9, and 25 in FIGS. 12-13), as will be appreciated by those skilled in the art, the disclosure is not so limited and each embodiment may include the number of teeth shown in another embodiment or any other suitable number of teeth extending therefrom. Additionally, each tooth 220 includes any suitable shape for penetrating the ground as the body portion 210 is rotated thereover. For example, each tooth 220 may have a symmetrical cross-sectional shape (e.g., the same shape facing the first side 211 and the second side 213), or the cross-sectional shape may be varied (e.g., different shapes facing the first side 211 and the second side 213). Each tooth 220 may also be tapered (e.g., conical) or consistent (e.g., rectangular) as it extends from the outer surface 215. Furthermore, in some embodiments, the teeth 220 may be multi-faceted. For example, in one embodiment, as best illustrated in FIG. 2, the teeth 220 include a rounded shape 221 facing the second side 213, and multiple intersecting facets 223 facing the first side 211. Additionally or alternatively, the teeth 220 may include one or more beveled edges 225 towards a distal end of each tooth. Regardless of the specific shape of the teeth 220, each tooth includes an apex 227, which is the most distal point of the tooth with respect to the axis of rotation 230 or, for a tooth with a flat distal end, the center point of the distal end.

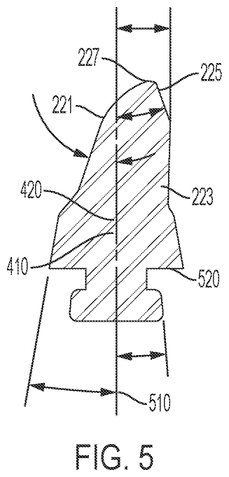

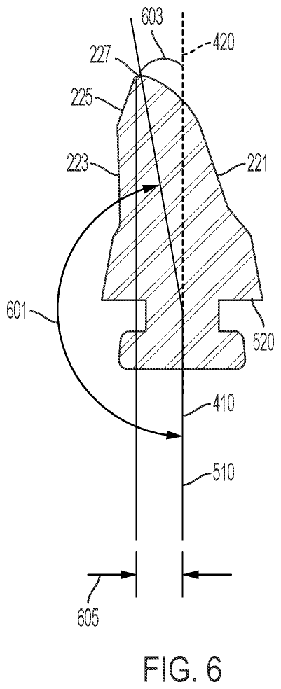

Turning to FIGS. 4-6, 10-11, and 14-15, in some embodiments, as best illustrated therein, at least one of the one or more teeth 220 extends from the outer surface 215 at an angle with respect to a plane 420 perpendicular to the axis of rotation 230. Although the plane 420 is shown as the centerline 410 of the wheel 200 in FIGS. 5, 11, and 15, as will be appreciated by those skilled in the art, the plane 420 may be shifted axially without changing the measured angle of the tooth 220. In some embodiments, the teeth 220 extend from the outer surface 215 at an angle 601 of up to 175°, between 150° and 175°, between 155° and 175°, between 150° and 170°, 155° and 170°, or any combination, sub-combination, range, or sub-range thereof. As will be appreciated by those skilled in the art upon reviewing FIG. 6, the angle 601 is measured from below the tooth 220, with a straight tooth having an angle of 180°. The same positioning may be described by an angle 603 measured from above the tooth 220, where a straight tooth would have an angle of 0°, and would include at least 5°, between 5° and 30°, between 5° and 25°, between 10° and 30°, between 10° and 25°, or any combination, sub-combination, range, or sub-range thereof.

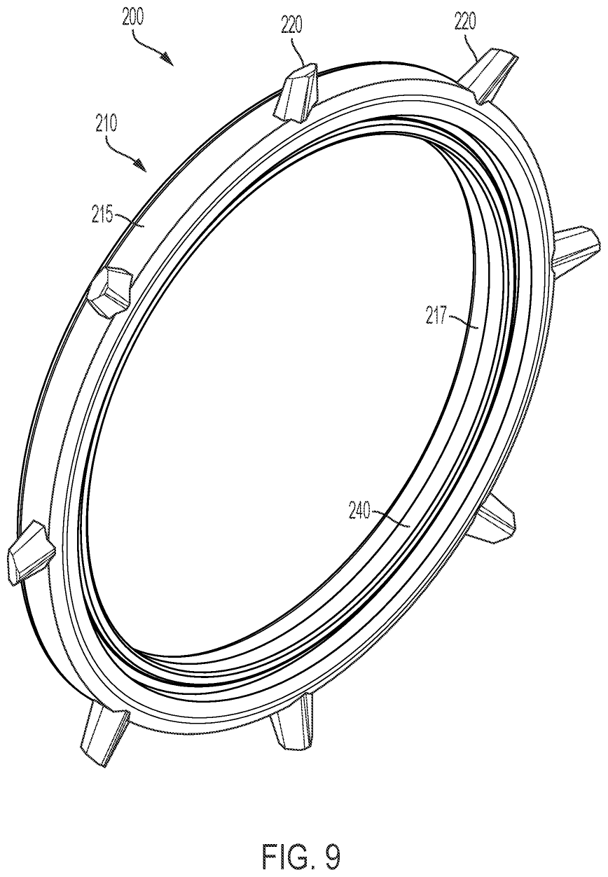

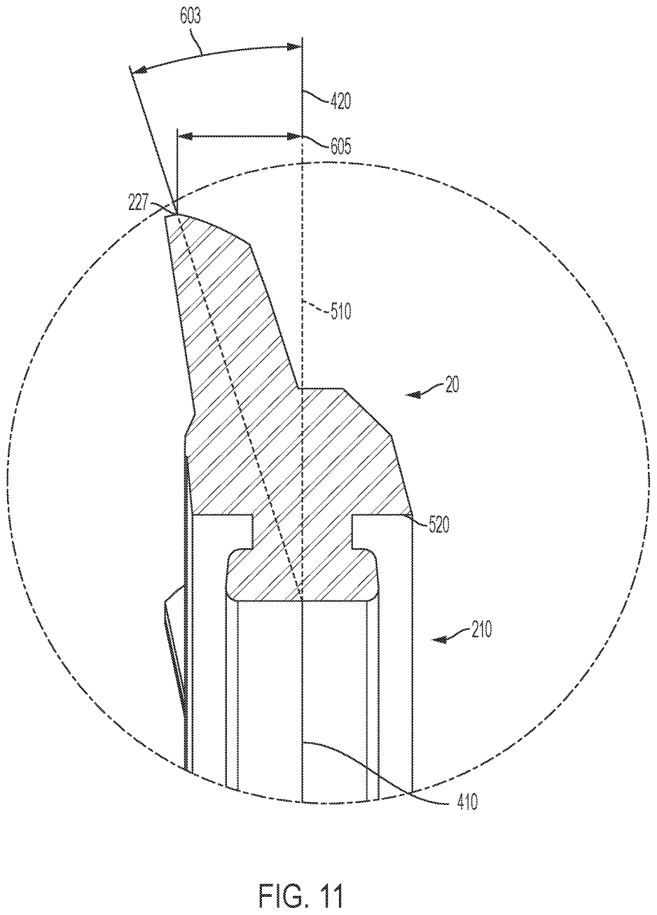

Additionally or alternatively, the positioning of the angled tooth 220 may be defined as an offset 605 of the apex 227 with respect to a tooth centerline 510. In some embodiments, the offset 605 is between 0.1 and 0.6 inches, between 0.1 and 0.5 inches, between 0.1 and 0.4 inches, between 0.1 and 0.3 inches, between 0.2 and 0.6 inches, between 0.2 and 0.5 inches, between 0.2 and 0.4 inches, about 0.1 inches, about 0.2 inches, about 0.3 inches, about 0.4 inches, about 0.5 inches, about 0.6 inches, or any combination, sub-combination, range, or sub-range thereof. The tooth centerline 510 is a plane perpendicular to the axis of rotation 230 and at the center of the tooth 220 with respect to a base portion 520 thereof. When the base portion 520 of the tooth 220 is centered on the body portion 210, as best shown in FIG. 11, the centerline 510 of the tooth 220 will be the same as the centerline 410 of the body portion 210/wheel 200. However, as will be appreciated by those skilled in the art, when the base portion 520 of the tooth 220 is not centered on the body portion 210, the centerline 510 of the tooth 220 will differ from the centerline 410 of the body portion 210. In either case, the offset 605 will reflect the angle of the tooth 220 extending from the body portion 210. As will also be understood by those skilled in the art, depending upon the amount of offset 605 and/or length and angle 603 of the tooth 220, the apex 227 may be positioned between the edges of the body portion 210 (FIGS. 4-6), or the apex 227 may be positioned outside the edges of the body portion 210 (FIGS. 9-11).

Additionally or alternatively, in some embodiments, as illustrated in FIGS. 12-15, at least one of the one or more teeth 220 is slanted in a circumferential/perimetral direction with respect to the body portion 210. In such embodiments, each slanted tooth 220 extends from the body portion 210 at an angle 1201 with respect to the normal direction at a perimetral center of the tooth 220. In some embodiments, where the tooth 220 is tapered, the slant causes a leading edge of the tooth 220 to have a different angle 1203 as compared to a trailing edge and/or the angle 1201. In such embodiments, the different angles of the leading and trailing edges creates a narrower angle 1205 between teeth as compared to tapered teeth without a slant.

Each of the body portion 210 and the teeth 220 may be independently made of any suitable material. In some embodiments, the body portion 210 is made from plastic. Suitable plastic materials include, but are not limited to, TPU (Thermoplastic Polyurethane), Polyamides, PETG (Polyethylene Terephthalate Glycol), UHMW-PE (Ultra High Molecular Weight-Polyethylene), PKE (Polyketone), PP (Polypropylene) and PTFE (Polytetrafluoroethylene). Additionally or alternatively, in some embodiments, the plastic may include any suitable reinforcement that allows for abrasion resistance, durability, impact resistance, chemical resistance, UV (Ultra-Violet) damage resistance, Ozone damage resistance, lubrication, low-friction, non-sticking ability, or combinations thereof. The reinforcement, when present, includes any suitable reinforcement material or combination of materials (e.g., glass, glass fiber, silica, carbon fiber, or other material) in any suitable concentration. Suitable reinforcement percentages include, but are not limited to, up to 50%. In some embodiments, the plastic includes an ultimate tensile strength of between 1,500 psi and 25,000 psi, a specific gravity of between 0.9 and 1.5, and/or a tensile modulus of elasticity of between 300,000 psi and 1,300,000 psi. For example, in one embodiment, the plastic includes Nylon glass fiber (GF) at 33% with an ultimate tensile strength of 17,500 psi, a specific gravity of 1.39, and a tensile modulus of elasticity of 1,250,225 psi. As will be understood by those skilled in the art, increasing or decreasing the GF percentage and/or modifying the plastic or reinforcement material will increase or decrease the properties respectively. Without wishing to be bound by theory, it is believed that, as compared to existing rubber materials, the plastic materials disclosed herein provides improved shedding of debris (e.g., mud) and/or increased durability.

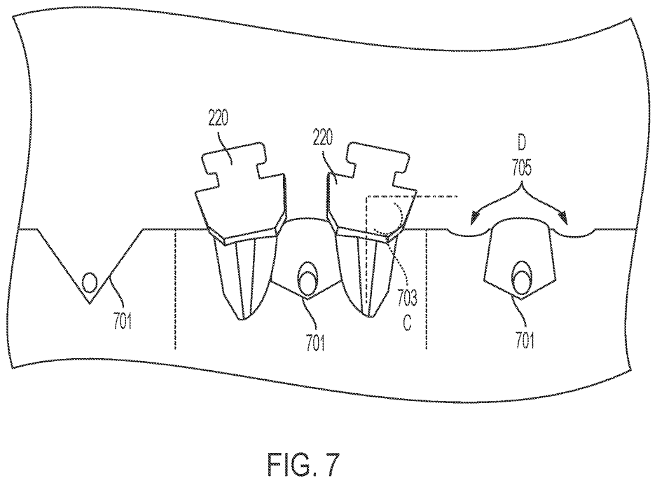

Also provided herein are methods of depositing seeds and/or covering a furrow. In some embodiments, as illustrated in FIG. 7, the method includes rotating a spiked closing wheel 200 according to one or more of the embodiments disclosed herein along either side of a furrow 701. In some embodiments, the spiked closing wheels 200 are mounted on a frame or other support at an angle towards the furrow 701, such that the wheels get closer together as they approach the ground. In such embodiments, the angle of the teeth 220 extending from the body 210 provides an improved contact angle with the ground and/or tooth penetration into the soil. For example, in some embodiments, when the spiked closing wheels 200 are angularly mounted on the frame, the teeth 220 penetrate the soil and/or contact the outer edge of the furrow 701 at an average angle 703 of between 85° and 115°. Soil contact at this angle and this distance from the furrow centerline breaks the walls of the furrow, forces soil into the furrow 701, and packs the soil over anything deposited within the furrow 701 (e.g., a seed) to the right pressure, while simultaneously avoiding disturbances to the seedbed at the centerline of the furrow. That is, the spiked closing wheels 200 cover the furrow 701 and compact the soil to the right pressure to ensure proper soil-seed contact. Additionally or alternatively, the angle of the teeth 220 leaves vertical puddle locations 705 on the edge of the furrow 701, improving water conservation for young plant root systems. Moreover, the spiked closing wheel 200 according to the embodiments disclosed herein provide improved contact angle, soil penetration, and/or water conservation without using shims (e.g., spacers/washers) during mounting.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A spiked closing wheel comprising:
a body portion having:
a first side;
a second side; and
an outer surface extending between the first side and the second side; and
a plurality of teeth extending outwardly from the outer surface;
wherein at least one of the teeth extends from the outer surface at an angle with respect to a plane perpendicular to an axis of rotation of the wheel.

2. The spiked closing wheel of claim 1, further comprising:
an inner annular surface;
wherein the outer surface forms a corresponding outer annular surface.

3. The spiked closing wheel of claim 2, wherein the inner annular surface defines an opening extending between the first side and the second side.

4. The spiked closing wheel of claim 3, wherein the opening is concentric with the axis of rotation.

5. The spiked closing wheel of claim 3, wherein the opening is arranged and disposed for direct mounting to a frame.

6. The spiked closing wheel of claim 5, wherein the opening comprises a bearing.

7. The spiked closing wheel of claim 3, further comprising a hub removably secured within the opening.

8. The spiked closing wheel of claim 7, wherein the hub includes a second opening arranged and disposed for direct mounting to a frame.

9. The spiked closing wheel of claim 7, wherein the hub comprises a first hub section reversibly secured to a second hub section.

10. The spiked closing wheel of claim 1, wherein the body portion comprises a first body section reversibly secured to a second body section.

11. The spiked closing wheel of claim 10, wherein the plurality of teeth are removably secured between the first body section and the second body section.

12. The spiked closing wheel of claim 1, wherein each of the plurality of teeth extends outwardly from the outer surface at an angle of at least 5 degrees with respect to the plane.

13. The spiked closing wheel of claim 1, wherein each of the plurality of teeth extends outwardly from the outer surface at an angle of between 5 degrees and 30 degrees with respect to the plane.

14. The spiked closing wheel of claim 1, wherein each of the plurality of teeth is contoured.

15. The spiked closing wheel of claim 1, wherein each of the plurality of teeth is rotated with respect to the plane.

16. The spiked closing wheel of claim 1, wherein an apex of each of the teeth is axially offset with respect to a centerline of the body portion.

17. The spiked closing wheel of claim 16, wherein the offset is up to a distance of half the width of the body portion.
